(19) United States
(12) Patent Application Publication
(10) Pub. No.: US 2014/0367486 A1
(43) Pub. Date: Dec. 18, 2014

(54) LIQUID CONTAINER, ULTRASONIC ATOMIZATION DEVICE, AND ABSORPTION BODY

(71) Applicant: Sumitomo Chemical Company, Limited, Tokyo (JP)

(72) Inventors: Hiroyuki KAWANO, Hyogo (JP); Tetsuo HARADA, Hyogo (JP); Daisuke TAKAHATA, Saitama (JP); Kazuyuki UEDA, Saitama (JP)

(21) Appl. No.: 14/471,225

(22) Filed: Aug. 28, 2014

Related U.S. Application Data
(63) Continuation-in-part of application No. PCT/JP2013/053567, filed on Feb. 14, 2013.

(30) Foreign Application Priority Data
Feb. 29, 2012 (JP) 2012-044143

(51) Int. Cl. B05B 17/00; B05B 17/06

(52) U.S. Cl. CPC B05B 17/0646; B05B 17/0684
USPC 239/102.2

(57) ABSTRACT

An ultrasonic atomizing device (1) includes (i) a liquid absorbent wick (22) which absorbs liquid from a solution container (20) and (ii) an absorber (23) which supplies, to a vibrating plate (32), the liquid absorbed by the liquid absorbent wick (22). The absorber (23) is configured to be provided to or removed from the ultrasonic atomizing device (1) together with the solution container (20) when the solution container (20) is provided to or removed from the ultrasonic atomizing device (1).

This is a continuation-in-part of PCT International Application No. 2013-053567 filed on Feb. 14, 2013, which claims priority over Japanese Patent Application No. 2012-044143 filed on Feb. 29, 2012, the entire contents of both of which are hereby incorporated by reference.

### TECHNICAL FIELD

The present invention relates to (i) a liquid container for use in an ultrasonic atomizing device which atomizes liquid such as water or a solution by ultrasonic vibration, (ii) an ultrasonic atomizing device, and (iii) an absorber.

### BACKGROUND ART

An ultrasonic atomizing device has been known as means for atomizing, in an interior or exterior space, liquid such as a solution containing an active ingredient. The ultrasonic atomizing device includes (i) a piezoelectric element which generates ultrasonic vibration when supplied with electricity and (ii) a vibrating plate which has many micropores and is attached to the piezoelectric element. The ultrasonic atomizing device is configured so as to atomize liquid by (i) supplying the liquid to the micropores and (ii) causing ultrasonic vibration on the vibrating plate by vibration of the piezoelectric element.

A piezoelectric atomizing device of Patent Literature 1 includes a liquid absorbent wick, a liquid container and a piezoelectric atomizing section. The liquid absorbent wick is divided into a first section to pass the solution and a second section to pass the solution. The first section to pass the solution is provided to the liquid container, and the second section to pass the solution is provided to a body of the piezoelectric atomizing device.

According to a piezoelectric atomizing device of Patent Literature 2, a piezoelectric atomizing section and a liquid absorbent wick are attached to a liquid container. The piezoelectric atomizing section and the liquid absorbent wick, together with the liquid container, are removably contained in a body of the piezoelectric atomizing device.

### CITATION LIST

### Patent Literatures

Patent Literature 1

Japanese Patent Application Publication, Tokukaihei, No. 11-221505 A (Publication Date: Aug. 17, 1999)

Patent Literature 2

Japanese Patent Application Publication, Tokukai, No. 2000-51755 A (Publication Date: Feb. 22, 2000)

### SUMMARY OF INVENTION

### Technical Problem

However, the piezoelectric atomizing devices of Patent Literatures 1 and 2 have the following problems.

Specifically, according to the piezoelectric atomizing device of Patent Literature 1, the second section to pass the solution is provided to a body of the piezoelectric atomizing device and is always in weak contact with or in contact with the vibrating plate. Therefore, when the solution container becomes empty and the second section to pass the solution dries, the micropores of the vibrating plate would be clogged with the fibers etc. of the second section to pass the solution. This may cause the amount of atomized solution to be unstable. In order to eliminate this cause, it is necessary to replace the second section to pass the solution or the vibrating plate. However, the replacement of the vibrating plate is costly. If a user carries out the replacement of the second section to pass the solution or the vibrating plate himself, the vibrating plate may be strongly pressed against the second section to pass the solution or may not be in sufficient contact with the second section to pass the solution, for example. These are problems for stable atomizing of the solution.

According to the piezoelectric atomizing device of Patent Literature 2, the piezoelectric atomizing section and the liquid absorbent wick are attached to the solution container. Therefore, when the solution container is replaced, the piezoelectric atomizing section is also to be replaced. This imposes a burden of high replacement costs on a user.

The present invention has been made in order to solve the above problems, and an object of the present invention is to provide an ultrasonic atomizing device which is capable of reducing a burden on a user.

### Solution to Problem

An ultrasonic atomizing device in accordance with the present invention is an ultrasonic atomizing device including a liquid container, a piezoelectric element, and a vibrating plate, the ultrasonic atomizing device including the vibrating plate, which vibrates in accordance with the piezoelectric element, so as to atomize liquid contained in the liquid container, the liquid container including: a liquid absorbent wick for absorbing the liquid from the liquid container; and an absorber for supplying, to the vibrating plate, the liquid absorbed by the liquid absorbent wick, the liquid container being removably provided to the ultrasonic atomizing device, and the absorber being configured to be provided to or removed from the ultrasonic atomizing device together with the liquid container when the liquid container is provided to or removed from the ultrasonic atomizing device.

According to the configuration, the ultrasonic atomizing device includes the vibrating plate, and the liquid container which is removably provided to the ultrasonic atomizing device has the liquid absorbent wick and the absorber. The absorber is, when the liquid container is provided to or removed from the ultrasonic atomizing device, provided to or removed from the ultrasonic atomizing device together with the liquid container.

That is, when the liquid container is removed from the ultrasonic atomizing device, the absorber is removed together with the liquid container and thus is not left in the ultrasonic atomizing device. That is, when the liquid container is to be replaced because the liquid container has become empty and the absorber has dried, the liquid container is replaced together with the absorber. This makes it possible to reduce the possibility of clogging micropores of the vibrating plate with fibers etc. derived from the absorber when the ultrasonic atomizing device is turned on again. As such, the ultrasonic atomizing device in accordance with the present invention less causes the amount of atomized liquid to be unstable due to the clogging, and less causes a user to replace costly vibrating plates.

In addition, since the ultrasonic atomizing device in accordance with the present invention includes the piezoelectric element and the vibrating plate, it is not necessary to replace the piezoelectric element and the vibrating plate when replacing the liquid container. This makes it possible to inexpensively replace the liquid container.

As has been described, the ultrasonic atomizing device in accordance with the present invention makes it possible to reduce the burden on a user in terms of costs, and also possible to enhance atomization stability of the ultrasonic atomizing device because clogging of the micropores of the vibrating plate is suppressed.

### Advantageous Effects of Invention

As has been described, an ultrasonic atomizing device in accordance with the present invention includes: a liquid absorbent wick for absorbing liquid from a liquid container; and an absorber for supplying, to the vibrating plate, the liquid absorbed by the liquid absorbent wick, the absorber being configured to be provided to or removed from the ultrasonic atomizing device together with the liquid container when the liquid container is provided to or removed from the ultrasonic atomizing device.

Accordingly, it is possible to provide an ultrasonic atomizing device capable of reducing a burden on a user.

### BRIEF DESCRIPTION OF DRAWINGS

FIG. 1 is a view schematically illustrating an ultrasonic atomizing device in accordance with the present embodiment.

FIG. 2 is an enlarged view of an atomization section of the ultrasonic atomizing device in accordance with the present embodiment.

FIG. 3 shows embodiments of an integrated structure in which a liquid absorbent wick is integral with an absorber. (a) of FIG. 3 shows a cap structure, (b) of FIG. 3 shows a cotton swab structure, (c) of FIG. 3 shows a fit-in structure, and (d) of FIG. 3 shows a double-wick structure.

FIG. 4 shows embodiments of an integrated structure in which a liquid absorbent wick is integral with an absorber. (a) of FIG. 4 shows a double-wick cotton swab structure, (b) of FIG. 4 shows a bonded structure, (c) of FIG. 4 shows a straw-shaped bonded structure, and (d) of FIG. 4 shows a straw-shaped cotton swab structure.

FIG. 5 is a table showing how atomization stability of an ultrasonic atomizing device was affected by (i) a speed (mm/s) of liquid absorption of a liquid absorbent wick and (ii) a weight (mg) of liquid held by an absorber.

### DESCRIPTION OF EMBODIMENTS

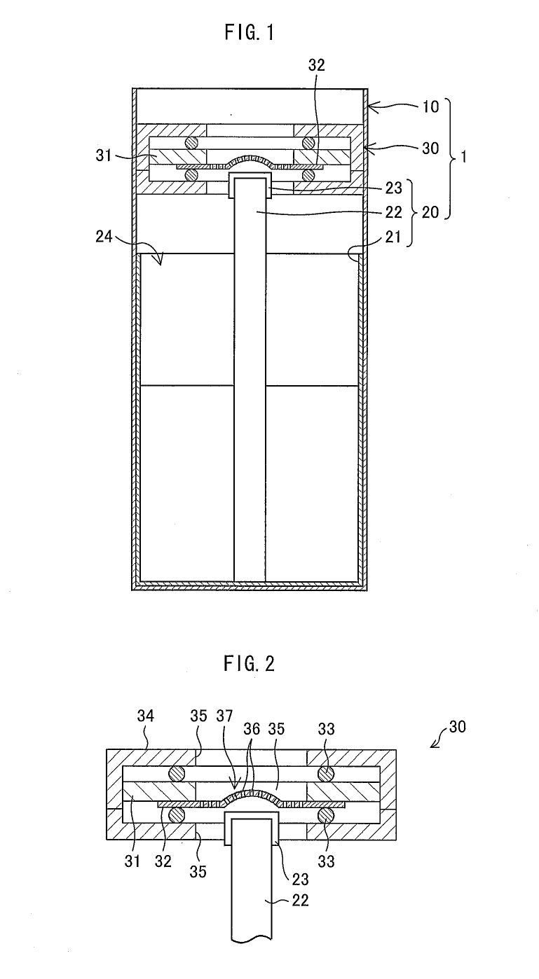

First, the following description discusses, with reference to FIG. 1 etc., an ultrasonic atomizing device 1, a solution container (liquid container) 20 and an absorber 23 in accordance with the present embodiment. FIG. 1 is a view schematically illustrating the ultrasonic atomizing device 1. FIG. 2 is an enlarged view of an atomization section 30 of the ultrasonic atomizing device 1.

### (Ultrasonic Atomizing Device 1)

The ultrasonic atomizing device 1 is a device for atomizing liquid such as water or a solution by ultrasonic vibration. The ultrasonic atomizing device 1 includes (i) a device body 10 which includes the atomization section 30 and (ii) a solution container 20 which is removably provided to the device body 10. The following description is based on the assumption that the liquid is water or a solution such as liquid of insecticide, pesticide or perfume.

(Device Body 10)

The device body 10 includes the atomization section 30, and is provided with the solution container 20 which is removable. The atomization section 30 includes (i) a piezoelectric element 31 which generates ultrasonic vibration when supplied with electricity, (ii) a vibrating plate 32 which atomizes a solution by vibration of the piezoelectric element 31, (iii) a couple of elastic rings 33 which are elastic annular members provided along a top surface of the piezoelectric element 31 and a bottom surface of the vibrating plate 32, respectively, and (iv) a casing 34 which holds the piezoelectric element 31 and the vibrating plate 32 by elastically sandwiching the piezoelectric element 31 and the vibrating plate 32 via the couple of elastic rings 33 (see FIG. 2).

The piezoelectric element 31 is constituted by a thin circular piezoelectric ceramic plate, which has an opening 35 at its center. The piezoelectric element 31 is polarized along its thickness direction, and generates ultrasonic vibration in a radial direction upon application of a high frequency voltage to electrodes (not illustrated) provided on both surfaces of the piezoelectric element 31. The piezoelectric element 31 is not limited provided that for example its thickness is 0.1 mm to 4.0 mm, its outer diameter is 6 mm to 60 mm, and its oscillatory frequency is 30 kHz to 500 kHz.

The vibrating plate 32 is constituted by a thin circular plate made of for example nickel. The vibrating plate 32 covers the opening 35 of the piezoelectric element 31, and, in FIG. 1, is joined (fastened) to a bottom surface of the piezoelectric element 31 so as to be concentric with the piezoelectric element 31. The thickness of the vibrating plate is for example 0.02 mm to 2.0 mm, and the outer diameter of the vibrating plate 32 is for example 6 mm to 60 mm. The outer diameter of the vibrating plate 32 is selected as appropriate depending on the size of the piezoelectric element 31 so as to be larger than the inner diameter of the opening 35 of the piezoelectric element 31.

The vibrating plate 32 has, in its part that faces the opening 35 of the piezoelectric element 31, many micropores 36 passing through the vibrating plate 32 in a thickness direction. The diameter of each of the micropores 36 is preferably 3 μm to 150 μm.

The vibrating plate 32 has, at its center, a convex part 37 constituted by a curved surface from top to bottom. The convex part 37 is a dome-shaped part which protrudes upward (in a direction in which a solution is to be atomized). Since the center of the vibrating plate 32 is dome-shaped, it is possible to more easily atomize the solution extensively. The convex part 37 generates ultrasonic vibration in a vertical direction when the piezoelectric element 31 extends and contracts (vibrates) in the radial direction.

There is provided the couple of elastic rings 33. The couple of elastic rings 33 are in contact with the top surface of the piezoelectric element 31 and the bottom surface of the vibrating plate 32, respectively, so as to be concentric with the piezoelectric element 31 and the vibrating plate 32, respectively. Here, the couple of elastic rings 33 are in a state of elastic deformation between the casing 34 and the top surface of the piezoelectric element 31 and between the casing 34 and the bottom surface of the vibrating plate 32, respectively.

Each of the couple of elastic rings 33 is preferably an O-ring having a section diameter of 0.5 mm to 3 mm. Further, the hardness of the couple of elastic rings 33 is preferably 20 IRHD to 90 IRHD. Such a couple of elastic rings 33 makes it possible to hold the piezoelectric element 31 and the vibrating plate 32 with appropriate elasticity, and thus effectively prevent excessive vibration of the piezoelectric element 31 and the vibrating plate 32. Accordingly, it is possible to atomize a solution in a more stable manner.

It should be noted that an elastic ring 33 in contact with the top surface of the piezoelectric element 31 and an elastic ring 33 in contact with the bottom surface of the vibrating plate 32 are preferably the same in terms of mean diameter [(Inner diameter+Outer diameter)/2], section diameter, and hardness etc. In particular, the couple of elastic rings 33 preferably have the same mean diameter.

The couple of elastic rings 33 are made from for example nitrile rubber, fluororubber, ethylene propylene rubber, silicone rubber, acrylic rubber, hydrogenated nitrile rubber, and/or the like.

Each of the couple of elastic rings 33 can be, instead of the O-ring, a ring that has for example an elliptic, rectangular, triangular or rhombic cross section. Alternatively, each of the couple of elastic rings 33 can be a ring that has for example a D-shaped, X-shaped or T-shaped cross section. Each of the couple of elastic rings 33 does not necessarily have to be a circumferentially continuous and complete ring, and therefore can have a slit in a circumferential direction or have several slits at regular intervals along the circumferential direction.

The convex part 37 of the vibrating plate 32 is not limited to a dome-shaped part whose top is constituted by a curved surface, and can have any shape such as a shape of a conical frustum whose top is constituted by a flat surface.

Note here that a frustum means a solid figure obtained by removing, from a first cone/pyramid, a second cone/pyramid which shares a vertex of the first cone/pyramid and which is similarly reduced in size. In other words, the frustum means a solid figure surrounded by a conical/pyramidal surface and two parallel flat surfaces. A frustum obtained from a cone is referred to as a conical frustum. A frustum obtained from a pyramid is referred to as a pyramidal frustum. A frustum obtained from n-sided pyramid is referred to as an n-sided-pyramidal frustum.

In a case where the convex part 37 has a shape of a conical frustum, an upper surface of the convex part 37, on which upper surface the micropores 36 are formed, serves as an upper base of the conical frustum, and a surface of the convex part 37 which surface rises from the vibrating plate 32 serves as a conical surface of the conical frustum. A liquid absorbent wick 22 and the absorber 23 are positioned at part of the convex part 37 which part corresponds to a lower base (which does not exist) of the conical frustum. From the absorber 23, liquid is supplied to the convex part 37.

More specifically, a case where the frustum is a conical frustum will be described below. It is preferable that a diameter of the upper base of the convex part 37 having the shape of a conical frustum be smaller than that of the liquid absorbent wick 22 having a cylindrical shape. Meanwhile, it is preferable that a diameter of the lower base (which does not exist) of the convex part 37 be equal to or slightly larger than that of the liquid absorbent wick 22. Specifically, the diameter of the upper base of the convex part 37 having the shape of a conical frustum is preferably not less than 1.0 mm and not more than 7.0 mm. The diameter of the lower base (which does not exist) of the convex part 37 is preferably not less than 2.2 mm and not more than 11.0 mm. A height of the convex part 37 (a distance between the upper base and the lower base) is preferably not less than 0.1 mm and not more than 2.0 mm. An angle between the lower base of the convex part 37 and the conical surface of the convex part 37 is preferably not more than 45 degrees.

The vibrating plate 32 is not limited to the convex vibrating plate which has the convex part 37 protruding in an atomization direction as described above as an example. The vibrating plate 32 can be a concave vibrating plate which has a concave part (i.e., a convex part 37 protruding in a direction opposite to the atomization direction). The vibrating plate 32 can be a flat vibrating plate which does not have any convex or concave part at its center.

Although the foregoing description discussed the vibrating plate 32 in the form of a thin circular plate which completely covers the opening 35 of the piezoelectric element 31, it is also possible to employ a vibrating plate in the form of a thin rectangular plate (i) which traverses the opening 35 of the piezoelectric element 31 and (ii) whose both ends are fastened to one surface of the piezoelectric element 31.

The atomization section 30 is not limited to the foregoing configuration, and can be constituted by a known piezoelectric atomization section. The atomization section 30 can be selected as appropriate.

(Solution Container 20)

The solution container 20 is constituted by a container body 21, a liquid absorbent wick 22 and an absorber 23, and is removably provided to the device body 10.

The container body 21 is constituted by for example a cylindrical container which has a bottom surface and has an opening 24 at the top. The container body 21 contains a solution. The container body 21 is made from for example glass or a synthetic resin.

The liquid absorbent wick 22 is for example made of nonwoven fabric and in columnar shape having a diameter of 2 mm to 6 mm. A lower portion of the liquid absorbent wick 22 is immersed in the solution contained in the container body 21. This makes it possible to supply the solution to an upper portion of the liquid absorbent wick 22 by capillary action. The absorber 23 is provided to the upper portion of the liquid absorbent wick 22.

The shape of the liquid absorbent wick 22 is not limited to a circular column, and can be a square column. The shape of the liquid absorbent wick 22 can be any shape. Furthermore, the thickness of the liquid absorbent wick 22 is not limited provided that the liquid absorbent wick 22 can pass through the opening 35 of the piezoelectric element 31.

The absorber 23 is provided to the upper portion of the liquid absorbent wick 22 so as to be integral with the liquid absorbent wick 22. That is, when the solution container 20 is provided to or removed from the ultrasonic atomizing device 1, the absorber 23 is also provided to or removed from the ultrasonic atomizing device 1 together with the solution container 20. The absorber 23 lies near or is in contact with the convex part 37 of the vibrating plate 32, and supplies, to the convex part 37, the solution absorbed by the liquid absorbent wick 22. This makes it possible to atomize the solution from the vibrating plate 32, and also possible to keep the stability of atomization amount. This will be described later in detail in Effect Confirmation Test.

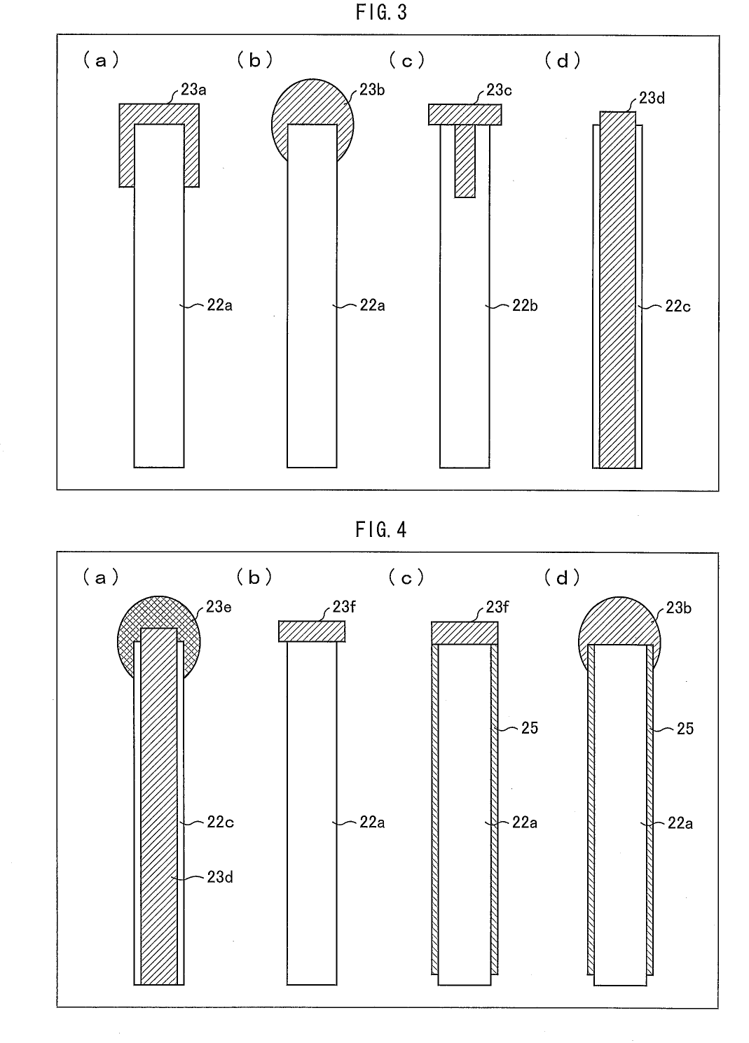

The integrated structure in which the liquid absorbent wick 22 is integral with the absorber 23 can be embodied in various manners. Some of them will be described later with reference to FIGS. 3 and 4. In the following description, the integrated structure in which the liquid absorbent wick 22 is integral with the absorber 23 may be referred to as a “double-wick integrated structure”.

In the present embodiment, the term “integral” means (i) members constitute a single member, (ii) members are assembled together, or (iii) the like.

The absorbent wick 22 and/or the absorber 23 are/is fixed to the container body 21, and removably attached to the solution container 20 (or the container body 21).

The liquid absorbent wick 22 and the absorber 23 are each preferably made of, for example, a porous material having continuous holes, an open-cell resin article, or an aggregation of resin fibers. Specific examples of materials from which the liquid absorbent wick 22 and the absorber 23 are made include, but not limited to: open-cell resin articles made of polyurethane, polyethylene, polyethylene terephthalate, polyvinyl formal and polystyrene etc.; porous materials obtained by sintering of fine resin particles made mainly of polyethylene, polypropylene, and nylon etc.; porous materials made of polyethylene fluoride etc.; aggregations of resin fibers, such as felt made of polyester, polypropylene, nylon, acrylic, rayon, wool etc. and nonwoven fabric made of polyolefin fibers, polyester fibers, nylon fibers, rayon fibers, acrylic fibers, vinylon fibers, polychlal fibers, aramid fibers etc.; and porous sintered inorganic materials obtained by sintering of mainly inorganic powder such as ceramics. The specific examples of the materials further include the above materials treated with a surfactant. The liquid absorbent wick 22 and the absorber 23 can be made of the same material or of different materials.

The absorber 23 preferably has such a property that a weight of normal paraffin (C12) held per 12 mm³ of the absorber 23 is not less than 54 mg, more preferably not more less than 54 mg and not more than 86 mg (later described). The liquid absorbent wick 22 preferably has such a property that a speed of absorbing the normal paraffin (C12) is not less than 0.24 mm/s and not more than 1.78 mm/s. The absorber 23 can be produced by (i) selecting, as appropriate, a material out of the foregoing materials having respective different porosities, and (ii) processing the material to a form which can be integrated with a liquid absorbent wick.

How to provide the solution container 20 to the device body 10 is not particularly limited, provided that (i) the solution container 20 is removably provided to the device body 10 and, (ii) while the device body 10 is provided with the solution container 20, the absorber 23 is near or in contact with the convex part 37 of the vibrating plate 32. For example, the solution container 20 can be provided to the device body 10 by (i) being slidingly fitted into the device body 10 by being slid laterally or (ii) being rotatingly fitted into the device body 10 by being rotated laterally with a slight rotational angle.

(Integrated Structure in which Liquid Absorbent Wick 22 is Integral with Absorber 23)

The following description discusses, with reference to FIGS. 3 and 4, embodiments of an integrated structure in which the liquid absorbent wick 22 is integral with the absorber 23. FIGS. 3 and 4 show embodiments of the integrated structure in which the liquid absorbent wick 22 is integral with the absorber 23. (a) of FIG. 3 shows a cap structure, (b) of FIG. 3 shows a cotton swab structure, (c) of FIG. 3 shows a fit-in structure, and (d) of FIG. 3 shows a double-wick structure. (a) of FIG. 4 shows a double-wick cotton swab structure, (b) of FIG. 4 shows a bonded structure, (c) of FIG. 4 shows a straw-shaped bonded structure, and (d) of FIG. 4 shows a straw-shaped cotton swab structure.

It should be noted that FIGS. 3 and 4 show basic shapes of the embodiments, and therefore length, depth, width, and relative sizes and relative positions of the liquid absorbent wick 22 and the absorber 23 can be altered as appropriate. Since the vibrating plate 32 is provided for the upper part and the solution container 20 is provided for the lower part of each of FIGS. 3 and 4, the absorber 23 is near or in contact with the vibrating plate 32 (not illustrated) which is provided for the upper part of each of FIGS. 3 and 4.

First, the following description discusses the cap structure shown in (a) of FIG. 3. The cap structure is a structure in which a top end of a liquid absorbent wick 22a is capped with an absorber 23a, which is in a U shape (concave shape), so as to be fitted in a concave part of the absorber 23a. In this way, the absorber 23a is provided so as to cap the top end of the liquid absorbent wick 22a and is integral with the liquid absorbent wick 22a. The absorber 23 shown in FIG. 2 has the cap structure. According to this structure, liquid-holding capacity of the absorber 23a facilitates stable supply of a solution to the vibrating plate 32 (not illustrated) provided at the top of (a) of FIG. 3.

Next, the following description discusses the cotton swab structure shown in (b) of FIG. 3. As illustrated in (b) of FIG. 3, the cotton swab structure is a structure in which an absorber 23b is integral with a liquid absorbent wick 22a, so that a shape defined by outer shapes of the liquid absorbent wick 22a and the absorber 23b resembles a cotton swab. According to this structure, the absorber 23b (i) is capable of supplying a solution stably to the vibrating plate 32 provided for the upper part of (b) of FIG. 3, because of its liquid-holding capacity and (ii) has a shape that corresponds to a convex shape of the vibrating plate 32.

The following description discusses the fit-in structure shown in (c) of FIG. 3. As illustrated in (c) of FIG. 3, the fit-in structure is a structure in which an absorber 23c has a T-shaped cross section and a bar-shaped part of the T shape is inserted in a liquid absorbent wick 22b. According to this structure, it is possible to hold the absorber 23c on the liquid absorbent wick 22b in a structurally stable manner.

The following description discusses the double-wick structure shown in (d) of FIG. 3. The double-wick structure is a structure in which an absorber 23d in the shape of a column is inserted and fitted in a liquid absorbent wick 22c along an entire axis of the liquid absorbent wick 22c. That is, the absorber 23d is inserted and fitted in the liquid absorbent wick 22c along the entire length of the liquid absorbent wick 22c, and one end of the absorber 23d is immersed in a solution in the container body 21. Therefore, according to the double-wick structure, the liquid absorbent wick 22c and the absorber 23d absorb the solution (liquid absorption) from the container body 21. Further, the absorber 23d plays a role of feeding the vibrating plate 32 with the solution absorbed by the liquid absorbent wick 22c, because the other end of the absorber 23d is near or in contact with the vibrating plate 32. This structure has such an advantage that, even in a case where the absorber 23d absorbs a solution slowly (e.g., in a case where the absorber 23d has a low porosity), it is possible to supply the solution stably to the vibrating plate 32 (not illustrated) by using the liquid absorbent wick 22c which absorbs the solution fast (e.g., the liquid absorbent wick 22c which has a high porosity).

As used herein the porosity is calculated from the following equation: Porosity={1−(Weight of liquid absorbent wick or Weight of absorber)/[(Volume of liquid absorbent wick or Volume of absorber)×(Density of material for liquid absorbent wick or Density of material for absorber)]}×100. The same applies to the following Examples.

The following description discusses the double-wick cotton swab structure shown in (a) of FIG. 4. As illustrated in (a) of FIG. 4, the double-wick cotton swab structure is a combination of the cotton swab structure shown in (b) of FIG. 3 and the double-wick structure shown in (d) of FIG. 3. The double-wick cotton swab structure includes a liquid absorbent wick 22c, an absorber 23d and an absorber 23e. The absorber 23d and the absorber 23e can be made of the same material or different materials. This structure has such an advantage that, even in a case where the absorber 23d absorbs a solution slowly (e.g., in a case where the absorber 23d has a low porosity), it is possible to supply the solution stably to the vibrating plate 32 by using the liquid absorbent wick 22c which absorbs the solution fast (e.g., the liquid absorbent wick 22c which has a high porosity). Furthermore, the absorber 23e is (i) capable of supplying the solution stably to the vibrating plate 32, because of its liquid-holding capacity and (ii) has a shape that corresponds to the convex shape of the vibrating plate 32.

The following description discusses the bonded structure shown in (b) of FIG. 4. The bonded structure is a structure in which an absorber 23f is bonded to a liquid absorbent wick 22a with use of an adhesion member such as an adhesive agent. The adhesion member preferably has properties that do not interrupt the supply of a solution from the liquid absorbent wick 22a to the absorber 23f. The adhesion member can be applied to the entire surfaces of the liquid absorbent wick 22a and the absorber 23f which surfaces are to be in contact with each other, or can be applied to only part of the surfaces. If the adhesion member is applied to only part of the surfaces, it is possible to reduce raw material costs.

The following description discusses the straw-shaped bonded structure shown in (c) of FIG. 4. The straw-shaped bonded structure is a structure in which a liquid absorbent wick 22a is inserted and fitted in a straw-like tube 25. An absorber 23f is integral with one end (for the vibrating plate side) of the liquid absorbent wick 22a which is inserted and fitted in the straw-like tube 25. The straw-like tube 25 is made of a material that does not absorb solutions. According to this structure, since a solution can be absorbed only by an end portion placed in the lower part of (c) of FIG. 4, it is possible to (i) prevent the speed of liquid absorption from being affected by the height from the bottom surface of the container to a surface of the solution and (ii) prevent spontaneous evaporation from the liquid absorbent wick 22a.

The following description discusses the straw-shaped cotton swab structure shown in (d) of FIG. 4. As illustrated in (d) of FIG. 4, the straw-shaped cotton swab structure is the same as the straw-shaped bonded structure shown in (c) of FIG. 4 except that the absorber 23b shown in (b) of FIG. 3 is used instead of the absorber 23f. The straw-shaped cotton swab structure includes a liquid absorbent wick 22a, the absorber 23b and a tube 25. According to the straw-shaped cotton swab structure, since the absorber 23b is capable of absorbing a solution only via one end portion of the liquid absorbent wick 22a, it is possible to prevent the speed of liquid absorption from being affected by the height from the bottom surface of the container to the surface of the solution. Furthermore, the tube 25 prevents spontaneous evaporation from the liquid absorbent wick 22a. Moreover, according to the straw-shaped cotton swab structure, the absorber 23b is (i) capable of supplying the solution stably to the vibrating plate 32, because of its liquid-holding capacity and (ii) has a shape that corresponds to the convex shape of the vibrating plate 32.

The foregoing descriptions discussed various embodiments with reference to FIGS. 3 and 4. As has been described, the absorber 23 which can have various shapes and structures is provided so as to be integral with the liquid absorbent wick 22.

As illustrated in FIGS. 3 and 4, a surface of the absorber 23, which surface is to be in contact with the vibrating plate 32, can have various shapes such as a convex, concave or flat shape. Note however that the surface of the absorber 23, which surface is to be in contact with the vibrating plate 32, preferably has a shape that corresponds to a surface of the vibrating plate 32 which surface is to be in contact with the absorber 23. That is, it is preferable that, in a case where the vibrating plate 32 has a concave, convex or flat shaped surface opposite to a surface from which a solution is to be atomized, the surface of the absorber 23 which surface is to be in contact with the vibrating plate 32 has a convex, concave or flat shape, accordingly.

Such an absorber 23 makes it possible to keep a good contact between the vibrating plate 32 and the absorber 23. This reduces or eliminates the factors which would affect the atomization stability of the solution, which factors are for example excessive or insufficient contact between the vibrating plate 32 and the absorber 23. As has been described, the liquid absorbent wick 22 and/or the absorber 23 can have various integrated structures depending on the shape and/or characteristics of the vibrating plate 32. This makes it possible to achieve optimum atomizing of a solution.

The liquid absorbent wick 22 and/or the absorber 23 can be provided so as to be (i) fixed to the container body 21 but (ii) detachable from the solution container 20 (or the container body 21). This provides such an advantage that, for example in a case where the liquid absorbent wick 22 and/or the absorber 23 have/has a failure but there is still some solution left in the solution container 20, it is possible to replace only the liquid absorbent wick 22 and/or the absorber 23 to thereby allow the ultrasonic atomizing device 1 to operate without losing atomization stability. This makes it possible to provide added value for a user, such as reduced costs for parts (members) replacement and effective use of solutions.

(Effect Confirmation Test)

The following description discusses the present invention in more detail with Examples. Note, however, that these Examples do not imply any limitation on the present invention.

(Production of Ultrasonic Atomizing Device)

An ultrasonic atomizing device having the following specifications was produced.

(1) Piezoelectric element 31: Piezoelectric ceramics whose outer diameter is 15 mm, inner diameter is 5 mm and thickness is 0.4 mm
(2) Vibrating plate 32: Convex vibrating plate
(3) Applied voltage: 30 Vp-p
(4) Frequency of piezoelectric element 31 (ultrasonic exciter): 110 kHz

### (Production of Wick Having Double-Wick Integrated Structure)

Wicks each having a double-wick integrated structure, which have the following specifications, were produced.

(Wick A Having Double-Wick Integrated Structure)

A wick A having a double-wick integrated structure used in this effect confirmation test corresponds to the cap structure shown in (a) of FIG. 3.

(1) Liquid absorbent wick 22: Aggregate of polypropylene resin fibers and polyethylene resin fibers, whose inner diameter is 4.5 mm
(2) Absorber 23: Aggregate of wood pulp and synthetic fibers (Product name: AY-80 (produced by OJI KINOCLOTH CO., LTD.))
(3) Integrated structure: Liquid absorbent wick 22 is capped with absorber 23, and liquid absorbent wick 22 and absorber 23 are held by seal tube

(Wick B Having a Double-Wick Integrated Structure)

A wick B having a double-wick integrated structure used in this effect confirmation test corresponds to the cotton swab structure shown in (b) of FIG. 3.

(1) Liquid absorbent wick 22: Aggregate of polypropylene resin fibers and polyethylene resin fibers, whose inner diameter is 3.5 mm
(2) Absorber 23: Aggregate of wood pulp and synthetic fibers
(3) Integrated structure: Absorber 23 is placed around and held to liquid absorbent wick 22

(Wick C Having a Double-Wick Integrated Structure)

A wick C having a double-wick integrated structure used in this effect confirmation test corresponds to the straw-shaped cotton swab structure shown in (d) of FIG. 4.

(1) Liquid absorbent wick 22: Aggregate of polypropylene resin fibers and polyethylene resin fibers, whose inner diameter is 3.5 mm
(2) Tube 25: Tube made of polypropylene, whose inner diameter is 3.5 mm and outer diameter is 4.5 mm
(2) Absorber 23: Aggregate of wood pulp and synthetic fibers (Product name: BEMCOT M-3II (produced by Asahi Kasei Corporation))
(3) Integrated structure: Absorbent wick 22 is inserted into tube 25, and absorber 23 is placed around and held to tube

### Example 1

The wick A having the double-wick integrated structure was held, with an inner plug, to a container body 21 filled with a solution (EXXSOL D110 (produced by Exxon Mobil Corporation)). The solution was atomized for one (1) second with use of an ultrasonic atomizing device 1. After the solution was atomized 10 times, the amount of atomized solution per atomizing was calculated from a difference between weights before and after the atomizing. This test was conducted 4 times, and relative standard deviation was calculated from the results of 4 tests. As a result, the amount per atomizing was 13.0 mg and the relative standard deviation was 0.6%.

### Example 2

The wick B having the double-wick integrated structure was held, with an inner plug, to a container body 21 filled with a solution (EXXSOL D110 (produced by Exxon Mobil Corporation)). The solution was atomized for one (1) second with use of an ultrasonic atomizing device 1. After the solution was atomized 10 times, the amount of atomized solution per atomizing was calculated from a difference between weights before and after the atomizing. This test was conducted 4 times, and relative standard deviation was calculated from the results of 4 tests. As a result, the amount per atomizing was 11.9 mg and the relative standard deviation was 1.0%.

### Example 3

The wick C having the double-wick integrated structure was held, with an inner plug, to a container body 21 filled with a solution (EXXSOL D110 (produced by Exxon Mobil Corporation)). The solution was atomized for one (1) second with use of an ultrasonic atomizing device 1. After the solution was atomized 10 times, the amount of atomized solution per atomizing was calculated from a difference between weights before and after the atomizing. This test was conducted 4 times, and relative standard deviation was calculated from the results of 4 tests. As a result, the amount per atomizing was 9.3 mg and the relative standard deviation was 3.1%.

### Comparative Example 1

A liquid absorbent wick 22 was held, with an inner plug, to a container body 21 filled with a solution (EXXSOL D110). The solution was atomized for one (1) second with use of an ultrasonic atomizing device 1. After the solution was atomized 10 times, the amount of atomized solution per atomizing was calculated from a difference between weights before and after the atomizing. This test was conducted 4 times, and relative standard deviation was calculated from the results of 4 tests. As a result, the amount per atomizing was 8.7 mg and the relative standard deviation was 5.0%.

### Comparative Example 2

A tube 25 in which a liquid absorbent wick 22 had been inserted was held, with an inner plug, to a container body 21 filled with a solution (EXXSOL D110). The solution was atomized for one (1) second with use of an ultrasonic atomizing device. After the solution was atomized 10 times, the amount of atomized solution per atomizing was calculated from a difference between weights before and after the atomizing. This test was conducted 4 times, and relative standard deviation was calculated from the results of 4 tests. As a result, the amount per atomizing was 5.1 mg and the relative standard deviation was 12.4%.

A comparison between the results of Examples 1 and 2 and the result of Comparative Example 1 showed that, with use of the wick having the double-wick integrated structure (Examples 1 and 2), the amount of atomized solution is large and the atomization is more stable as compared to a structure which only includes the liquid absorbent wick 22 and does not include the absorber 23 (Comparative Example 1).

Further, a comparison between the result of Example 3 and the result of Comparative Example 2 showed that, with use of the wick having the double-wick integrated structure (Example 3), the amount of atomized solution is large and the atomization is more stable as compared to a structure which only includes the liquid absorbent wick 22 inserted in the tube 25 and does not include the absorber 23 (Comparative Example 2).

### Comparative Example 3

A liquid absorbent wick 22 was held, with an inner plug, to a container body 21 filled with a solution (EXXSOL D110), and an absorber 23 was provided for a vibrating plate 32 side (such a structure is hereinafter referred to as a wick having a double-wick separated structure). The solution was atomized for one (1) second with use of an ultrasonic atomizing device. After the solution was atomized 10 times, the amount of atomized solution per atomizing was calculated from a difference between weights before and after the atomizing. This test was conducted 4 times, and relative standard deviation was calculated from the results of 4 tests. As a result, the amount per atomizing was 13.4 mg and the relative standard deviation was 0.7%.

A comparison between the results of Example 1 and Comparative Example 3 showed that the wick having the double-wick integrated structure and the wick having the double-wick separated structure are not so different in terms of the amount of atomized solution and the atomization stability.

### Example 4

The wick A having the double-wick integrated structure was held, with an inner plug, to a container body 21 filled with a solution (EXXSOL D110 (produced by Exxon Mobil Corporation)). The solution was atomized for one (1) second with use of an ultrasonic atomizing device 1. After the solution was atomized 10 times, the amount of atomized solution per atomizing was calculated from a difference between weights before and after the atomizing. Furthermore, the container body 21 in which the wick A having the double-wick integrated structure had been held with the inner plug was removed from the ultrasonic atomizing device 1, and allowed to stand for 7 days. After 7 days, the container body 21 in which the wick A having the double-wick integrated structure had been held with the inner plug was again provided to the ultrasonic atomizing device 1, and the solution was atomized for one (1) second. After the solution was atomized 10 times, the amount of atomized solution per atomizing was calculated from a difference between weights before and after the atomizing. As a result, the amount per atomizing at first was 12.9 mg, and the amount per atomizing after 7 days was 13.1 mg.

### Comparative Example 4

A liquid absorbent wick 22 was held, with an inner plug, to a container body 21 filled with a solution (EXXSOL D110), and an absorber 23 was provided for a vibrating plate 32 side. The solution was atomized for one (1) second with use of an ultrasonic atomizing device 1. After the solution was atomized 10 times, the amount of atomized solution per atomizing was calculated from a difference between weights before and after the atomizing. Furthermore, the container body 21 in which the liquid absorbent wick 22 had been held with the inner plug was removed from the ultrasonic atomizing device 1, and allowed to stand for 7 days. Meanwhile, the absorber 23 was left on the vibrating plate 32. After 7 days, the container body 21 in which the liquid absorbent wick 22 had been held with the inner plug was again provided to the ultrasonic atomizing device 1, and the solution was atomized for one (1) second. After the solution was atomized 10 times, the amount of atomized solution per atomizing was calculated from a difference between weights before and after the atomizing. As a result, the amount per atomizing at first was 13.2 mg, and the amount per atomizing after 7 days was 9.8 mg.

A comparison between Example 4 and Comparative Example 4 showed that (i) in a case of the wick having the double-wick separated structure, the amount of atomized solution decreases as the absorber 23 dries, but (ii) in a case of the wick having the double-wick integrated structure, the amount of atomized solution does not decrease even when the absorber 23 dries.

The above results showed that the wick having the double-wick integrated structure of the present embodiment (i) compares favorably with the wick having the double-wick separated structure in terms of the amount of atomized solution and the atomization stability and (ii) is more excellent than the structures of Comparative Examples 1 and 2 (the structure which only uses a liquid absorbent wick) in terms of the amount of atomized solution and the atomization stability. The results showed that these advantages are achieved by employing a structure of the absorber which is integral with the liquid absorbent wick.

The results also showed that, with use of the wick having the double-wick integrated structure of the present examples, it is possible to prevent the micropores of the vibrating plate from being clogged with fibers etc. of a dried absorber, and thus possible to prevent the amount of atomized solution from being unstable.

(Effect Confirmation Test 2)

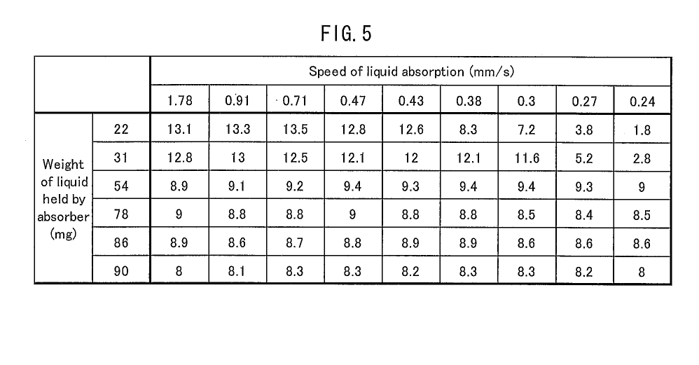

Next, the following description discusses, with reference to FIG. 5, how the atomization stability of the ultrasonic atomizing device 1 is affected by (i) a speed (mm/s) of liquid absorption of the liquid absorbent wick 22 and (ii) a weight (mg) of liquid held by the absorber 23. FIG. 5 is a table showing how atomization stability of an ultrasonic atomizing device 1 was affected by (i) a speed (mm/s) of liquid absorption of a liquid absorbent wick 22 and (ii) a weight (mg) of liquid held by an absorber 23.

A speed (mm/s) of liquid absorption of a liquid absorbent wick was measured by the following method.

Method of Measuring Speed Rate of Liquid Absorption of Liquid Absorbent of Wick

(a) A liquid absorbent wick was cut into a 64-mm-long piece (φ 3.5 mm).

(b) Normal paraffin (C12) (in the present example, cactus normal paraffin N12D manufactured by Japan Energy Corporation Ltd. was used) was dyed with methylene blue.

(c) 10 ml of the normal paraffin prepared in the (b) was put on a petri dish (level of the normal paraffin was 4 mm).

(d) The 64-mm-long piece of liquid absorbent wick prepared in the (a) was held to stand up at the center of the petri dish so as to be soaked in the normal paraffin.

(e) Time required for the liquid absorbent wick to be dyed to a top surface of the liquid absorbent wick was measured.

(f) A speed of liquid absorption was calculated from the time measured in the (e).

FIG. 5 shows results obtained by carrying out a test with the use of nine types of liquid absorbent wicks having respective different speeds in liquid absorption (i.e., 1.78 mm/s, 0.91 mm/s, . . . , 0.24 mm/s).

A weight (mg) of liquid held by an absorber was measured by the following method.

Method of Measuring Weight of Liquid Held by Absorber

(a) A cylinder-shaped absorber having a diameter of 6 mm and a height of 2 mm was punched out of a sheet-shaped absorber with the use of a punch.

(b) A weight of the cylinder-shaped absorber prepared in the (a) was measured.

(c) Normal paraffin (C12) (in the present example, cactus normal paraffin N12D manufactured by Japan Energy Corporation Ltd. was used) was dropped, with the use of a dropper, to the cylinder-shaped absorber prepared in the (a) until the normal paraffin overflowed from the cylinder-shaped absorber.

(d) A weight of the cylinder-shaped absorber which had held the normal paraffin in maximum amount in the (c) was measured.

(e) A weight of liquid held by the cylinder-shaped absorber was calculated from a difference between the weight measured in the (d) and the weight measured in (b).

FIG. 5 shows the results obtained by carrying out the test with the use of six types of absorbers which held liquid in respective different weights (i.e., 22 mg, 31 mg, . . . , 90 mg).

According to FIG. 5, for example, in a case where (i) a speed of liquid absorption was 1.78 mm/s and (ii) a weight of liquid held by an absorber was 22.0 mg, an amount of an atomized solution was 13.1 mg per atomizing. Note that each amount of atomized solutions shown in FIG. 5 is an average amount obtained by 10 times of atomization.

(Condition for Effect Confirmation Test 2)

(Production of Wick Having Double-Wick Integrated Structure)

Liquid absorbent wicks, each having a double-wick integrated structure, illustrated in (a) of FIG. 3 were produced with the use of (i) absorbers (cylinder-shaped absorbers each having a diameter of 6 mm and a height of 2 mm) which held liquid in respective different weights and (ii) liquid absorbent wicks which had respective different speeds in liquid absorption.

(Condition for Measurement of Amount of Atomized Solution)

Data shown in FIG. 5 was obtained under a condition that a temperature was 26° C., humidity was 50%, and a temperature of a paraffin solution was 24° C. The ultrasonic atomizing device 1 was set so as to atomize the solution with on-off operation in a cycle of 30 seconds in which the ultrasonic atomizing device 1 was tuned on for 1.0 second (the ultrasonic atomizing device 1 was caused to atomize the solution for 1.0 second) and was turned off for 29.0 seconds (the ultrasonic atomizing device 1 was stopped for 29.0 seconds). A vibrating plate 32 was a mesh of φ 8.5 μm and had a shape of a conical frustum.

An average amount obtained by 10 times of atomization (mg per atomizing) was taken as a result of the measurement of the amount of the solution atomized from the ultrasonic atomizing device 1.

(Result of Effect Confirmation Test 2)

A weight of liquid held by an absorber preferably falls within a range which allows the ultrasonic atomizing device 1 to keep stability of atomization. In this regard, it was found that, in a case where a weight of liquid held by an absorber is not less than 54 mg, an amount of the solution atomized by the ultrasonic atomizing device 1 is stable irrespective of a speed of liquid absorption of a liquid absorbent wick.

In a case where the weight of liquid held by the absorber 23 is smaller than 54 mg, the amount of the atomized solution greatly changes depending on the speed of liquid absorption of the liquid absorbent wick. This causes a variation in amount of the atomized solution. In a case where the weight of liquid held by the absorber 23 is larger than 90 mg, the amount of the atomized solution is small irrespective of the speed of liquid absorption of the liquid absorbent wick. This hinders the atomization. In this regard, in a case where the weight of liquid held by the absorber 23 is not less than 54 mg and not more than 86 mg, a suitable amount of the solution is stably atomized.

In the effect confirmation test 2, an amount of the solution supplied to the absorber 23 per unit of time is changed by changing the speed (mm/s) of liquid absorption of the liquid absorbent wick 22. In an actual use situation, the amount of the solution supplied to the absorber 23 per unit of time changes depending on a change in amount of the solution in a container or a change in ambient temperature. In a case where the weight (mg) of liquid held by the absorber 23 is not less than 54 mg, the amount of the atomized solution is stable even in a case where there are such changes.

The foregoing descriptions discussed various configurations of an ultrasonic atomizing device in accordance with the present embodiment. These configurations serve as examples of the present embodiment, and it is needless to say that configurations described in the present embodiment can be combined.

An ultrasonic atomizing device in accordance with the present embodiment can be one which has the following configuration. That is, the liquid container employed for the ultrasonic atomizing device in accordance with the present invention can be configured, such that the liquid absorbent wick and the absorber are detachably attached to the liquid container.

According to the configuration, for example in a case where the liquid absorbent wick and/or the absorber have/has a failure and there is some solution remaining in the liquid container, it is only necessary to replace only the liquid absorbent wick and the absorber. This makes it possible to provide added value for a user, such as reduced replacement cost and effective use of solutions.

An ultrasonic atomizing device in accordance with the present invention can include: the piezoelectric element; the vibrating plate; and the liquid container.

According to the configuration, when replacing the liquid container which has become empty, it is not necessary to also replace the piezoelectric element and the vibrating plate of the ultrasonic atomizing device, and thus is possible to keep using those piezoelectric element and vibrating plate. Furthermore, by using the above liquid container, micropores of the vibrating plate are less clogged with fibers etc. derived from the absorber.

Accordingly, the ultrasonic atomizing device in accordance with the present invention brings about the following effects: a user is not forced to replace the vibrating plate; and the amount of atomized liquid becomes stable.

An absorber employed for the ultrasonic atomizing device in accordance with the present invention can be configured, such that its surface to be in contact with the vibrating plate has a shape that corresponds to a surface, of the vibrating plate, which is to be in contact with the absorber.

The absorber employed for the ultrasonic atomizing device in accordance with the present invention can be configured, such that its surface to be in contact with the vibrating plate has a convex, concave or flat shape.

The shape of a surface, opposite to a surface from which the liquid is to be atomized, of the vibrating plate for use in the ultrasonic atomizing device can have various shapes such as a concave, convex or flat shape.

In this regard, the absorber employed for the ultrasonic atomizing device in accordance with the present invention can be configured, such that its surface to be in contact with the vibrating plate has a shape that corresponds to the surface, of the vibrating plate, which is to be in contact with the absorber. That is, for example in a case where the vibrating plate has a concave, convex or flat shaped surface opposite to a surface from which a solution is to be atomized, the surface of the absorber employed for the ultrasonic atomizing device in accordance with the present invention, which surface is to be in contact with the vibrating plate, can have a convex, concave or flat shape, accordingly.

Such an absorber employed for the ultrasonic atomizing device in accordance with the present invention makes it possible to keep a good contact between the vibrating plate and the absorber. This eliminates the factors which would affect atomization stability of the solution, which factors are attributed to excessive or insufficient contact between the vibrating plate and the absorber.

The present invention is not limited to the descriptions of the respective embodiments, but may be altered within the scope of the claims. That is, an embodiment derived from a combination of technical means altered as appropriate within the scope of the claims is encompassed in the technical scope of the invention.

### INDUSTRIAL APPLICABILITY

In particular, the present invention is suitably applicable to an ultrasonic atomizing device.

### REFERENCE SIGNS LIST

1 Ultrasonic atomizing device
10 Device body
20 Solution container (liquid container)
21 Container body
22, 22a through 22c Liquid absorbent wick
23, 23a through 23f Absorber
24 Opening
25 Liquid absorbent wick
30 Atomization section
31 Piezoelectric element
32 Vibrating plate
33 Elastic ring
34 Casing
35 Opening
36 Micropores
37 Convex part

1. An ultrasonic atomizing device comprising a liquid container, a piezoelectric element, and a vibrating plate,
the vibrating plate being configured to vibrate by and according to the piezoelectric element so as to atomize liquid contained in the liquid container,
the liquid container including:
a liquid absorbent wick for absorbing the liquid from the liquid container; and
an absorber for supplying, to the vibrating plate, the liquid absorbed by the liquid absorbent wick,
the liquid container being removably provided to the ultrasonic atomizing device, and
the absorber being configured to be provided to or removed from the ultrasonic atomizing device together with the liquid container when the liquid container is provided to or removed from the ultrasonic atomizing device.

2. The ultrasonic atomizing device according to claim 1, wherein the liquid absorbent wick and the absorber are detachably attached to the liquid container.

3. The ultrasonic atomizing device according to claim 1, wherein
a surface, of the absorber, which is to be in contact with the vibrating plate has a shape that corresponds to a surface, of the vibrating plate, which is to be in contact with the absorber.

4. The ultrasonic atomizing device according to claim 3, wherein the surface, of the absorber, which is to be in contact with the vibrating plate has a convex, concave or flat shape.

5. The ultrasonic atomizing device according to claim 1, wherein
the absorber is an absorber having such a property that a weight of normal paraffin (C12) held per 12 mm³ of the absorber is not less than 54 mg.

6. The ultrasonic atomizing device according to claim 5, wherein
the absorber is an absorber having such a property that the weight of the normal paraffin (C12) held per 12 mm³ of the absorber is not more than 86 mg.

7. The ultrasonic atomizing device according to claim 1, wherein
the liquid absorbent wick is a liquid absorbent wick having such a property that a speed of absorbing the normal paraffin (C12) is not less than 0.24 mm/s and not more than 1.78 mm/s.
